(19) United States
(12) Patent Application Publication
(10) Pub. No.: US 2012/0128869 A1
(43) Pub. Date: May 24, 2012

(54) PHASE CHANGE ENERGY STORAGE IN CERAMIC NANOTUBE COMPOSITES

(75) Inventor: Seth Adrian Miller, Englewood, CO (US)

(73) Assignee: EMPIRE TECHNOLOGY DEVELOPMENT LLC, Wilmington, DE (US)

(21) Appl. No.: 13/260,545

(22) PCT Filed: Sep. 29, 2010
(86) PCT No.: PCT/US2010/050674

§ 371 Date: Sep. 26, 2011

(51) Int. Cl. B05D 5/12; B05C 11/00; C09K 5/06; B82Y 40/00

(52) U.S. Cl. 427/118; 252/71; 252/78.3; 252/78.5; 252/74; 118/697; 977/840

(57) ABSTRACT

The present disclosure generally relates to methods and systems for forming phase change material composites and to the thus formed phase change material composites. In some examples, a method for forming a phase change material (PCM) composite may include dispersing nanowire material in a nonpolar solvent to form a nanowire-solvent dispersion, adding a PCM to the nanowire-solvent dispersion to form a nanowire-solvent-PCM dispersion, heating the nanowire-solvent-PCM dispersion, and removing the solvent.

### BACKGROUND

Unless otherwise indicated herein, the materials described in this section are not prior art to the claims in this application, and are not admitted to be prior art by inclusion in this section.

Portable chip-based devices such as cell phones, remote sensors, and communications lasers are characterized by brief bouts of intense activity followed by long periods of low-level use. Short, intense activity can cause significant heating to the internal electronics, which can degrade performance and may cause incompatibility with the electronic's immediate environment. To alleviate this heating problem, phase change materials (PCMs) can be placed in contact with the electronics to act as a thermal capacitor. The PCM absorbs thermal energy at the PCM melt transition, thereby removing heat from the electronics. Commonly used PCMs include wax materials because the phase change of wax material from solid to liquid allows absorption of significant energy. At the phase change (solid to liquid), the wax material becomes a low viscosity liquid and thus must be contained in a package or risk the liquid migrating through the electronics. Delamination of the wax containing package from the thermal source is a considerable problem that limits application of PCMs.

### SUMMARY

Methods and systems for forming phase change material composites and phase change material composites formed using the methods and systems are provided. In some examples, a method for forming a phase change material (PCM) composite may include dispersing nanowire material in a nonpolar solvent to form a nanowire-solvent dispersion, adding a PCM to the nanowire-solvent dispersion to form a nanowire-solvent-PCM dispersion, heating the nanowire-solvent-PCM dispersion, and removing the solvent.

In one example, a method for forming a phase change material (PCM) composite is provided. The method may include treating a nanowire material to enhance compatibility with the PCM, combining the nanowire material with PCM to form an admixture, and mixing the admixture to form a PCM-composite.

In another example, a system for forming a phase change material (PCM) composite is provided. The system may include a tank, a heating element, a forming element, and a controller. The tank may be configured to receive a solvent, a nanowire material, and a PCM. The heating element may be associated with the tank and configured to selectively heat the tank to a temperature suitable for removing the solvent. The forming element may be configured to form remaining PCM composite to a suitable shape and/or size. The controller may be coupled to one or more of the heating element and/or the forming element and configured to control process parameters associated with the system for forming the PCM.

In a further example, a computer accessible medium is provided. The computer accessible medium may have, stored thereon, computer executable instructions which, when executed by a computing device, configure the computing device to perform a method for forming phase change material (PCM) composites. The method may include dispersing a nanowire material in a nonpolar solvent to form a nanowire-solvent dispersion, adding a PCM to the nanowire-solvent dispersion to form a nanowire-solvent-PCM dispersion, and forming a resulting PCM composite by admixture of the PCM and nanowire material in the nanowire-solvent-PCM dispersion.

While multiple examples are disclosed, still other examples will become apparent to those skilled in the art from the following detailed description. As will be apparent, the systems, methods, and computer programs may be capable of modifications in various obvious aspects, all without departing from the spirit and scope of the teachings herein. Accordingly, the detailed description is to be regarded as illustrative in nature and not restrictive.

### BRIEF DESCRIPTION OF THE FIGURES

The foregoing and other features of the present disclosure will become more fully apparent from the following description and appended claims, taken in conjunction with the accompanying drawings. Understanding that these drawings depict only several examples in accordance with the disclosure and are, therefore, not to be considered limiting of its scope, the disclosure will be described with additional specificity and detail through use of the accompanying drawings, in which:

In the drawings:

FIG. 1 illustrates an example of a first method for forming a PCM composite;

FIG. 2 illustrates an example of a second method for forming a PCM composite;

FIG. 3 illustrates a schematic view of a first example system for forming a PCM composite;

FIG. 4 illustrates a schematic view of a second example system for forming a PCM composite;

FIG. 5 illustrates a schematic view of a third example system for forming a PCM composite;

FIG. 6 is a block diagram illustrating an example computing device that is arranged for forming a PCM composite; and

FIG. 7 illustrates a block diagram of an example computer program product, all arranged in accordance with at least some examples of the present disclosure.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the figures, may be arranged, substituted, combined, separated, and designed in a wide variety of different configurations, all of which are explicitly and implicitly contemplated herein.

This disclosure is drawn, inter alia, to methods, apparatus, computer programs and systems related to phase change energy storage in PCM composites such as ceramic nanotube composites. More specifically, various methods and systems for forming such composites and the composites thus formed are provided.

Briefly stated, the present disclosure generally relates to methods and systems for forming phase change material composites and to the thus formed phase change material composites. In some examples, a method for forming a phase change material (PCM) composite may includes dispersing nanowire material in a nonpolar solvent to form a nanowire-solvent dispersion, adding a PCM to the nanowire-solvent dispersion to form a nanowire-solvent-PCM dispersion, heating the nanowire-solvent-PCM dispersion, and removing the solvent.

In an alternative method, the PCM may be dissolved in a solvent to form a PCM-solvent dispersion and the nanowire material may be added to the PCM-solvent dispersion to form the nanowire-solvent-PCM dispersion. In yet a further method, the PCM and nanowire material may be added to a solvent substantially simultaneously to form the nanowire-solvent-PCM dispersion.

In various examples, nanowire material is mixed with a PCM to form a mesh PCM composite. The PCM may be a wax material that transitions from a solid state to a liquid state. Energy associated with the phase transition facilitates absorption of energy from an electronic circuit before the phase transition. In some examples, the energy is absorbed from a surface of the semiconductor die. In other examples, the energy is absorbed from a surface of a substrate that includes one or more semiconductor dies mounted thereon (e.g., adhesively bonded or eutecticly attached). In yet other examples, the energy is absorbed from a surface of an encapsulated package (e.g., ceramic, plastic, metal, etc.) of a circuit. In still other examples, the energy is absorbed from a surface of a circuit board (e.g., a printed circuit board).

The nanowires conduct heat efficiently through the PCM. Accordingly, the mixture of the nanowires and the PCM (referred to herein as a composite PCM) forms a nano-scale mesh having excellent thermal conductivity arising from the percolation network of the nanowires.

The composite PCM facilitates a rapid response to thermal energy of the electronics. PCM such as wax material is not itself very thermally conductive. The wax material is enclosed in a package that is thermally coupled to the electronics at a thermal interface (i.e., the portion of the electronics that are in thermal contact with the encapsulated wax material). However, the encapsulated wax material may not uniformly absorb thermal energy from the electronics. For example, some of the wax material that is closest to the thermal interface may begin to melt before other portions of the wax material that are further from the thermal interface. However, the nanostructure network of the nanowire material in the composite PCM results in a high packing of nanotubes, which facilitates more uniform dispersion of the thermal energy throughout the PCM composite.

The network of nanowires dispersed in the composite PCM constrains the PCM by capillary forces when it melts. The nanowires serve as a framework that creates the capillary pressures necessary to entrap molten PCM. The composite PCM substantially constrains the PCM in the molten state such that no further packaging is required. Further, the composite PCM maintains good thermal contact at the thermal interface (e.g., the thermal contact point between a substrate/electronic circuit and the packaged PCM composite) through thermal cycling. The composite PCM may be used as a heat sink for electronic circuits (e.g., semiconductor die or “chips”, hybrid circuits, PCBs, etc.) and other applications where heat sinking may be useful.

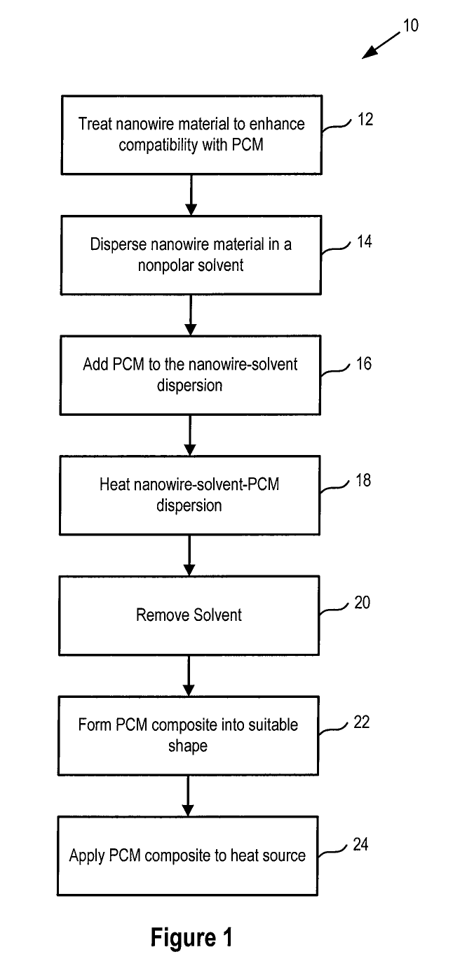

FIG. 1 illustrates an example of a first method 10 for forming a PCM composite, in accordance with at least some examples of the present disclosure. Generally, the PCM composite is created by mixing a phase change material (PCM), such as a wax material, with a covalent or surfactant modified nanowire. Above the melting temperature of the PCM, the liquid is held inside the nanowire network by capillary forces. The resultant PCM composite is soft and formable but has a limited ability to flow because flow requires movement of both the liquid PCM (molten wax) and the nanowires. The PCM composite has a modules of >1 GPa, despite generally comprising in excess of about 50% liquid material. The outside surface of the PCM composite wets when heated and conforms to any surface upon which it is disposed and further provides good adhesion through van der Waals forces.

Method 10 may comprise one or more functions, operations or actions as are illustrated by blocks 12, 14, 16, 18, 2, 220 and/or 24. Processing may begin at block 12.

At block 12, nanowire material may be treated to enhance compatibility with PCM. The nanowire material may be chosen based on its ability to be made chemically compatible with the PCM and based on its thermal conductivity and ability to efficiently transfer thermal energy throughout the wax material. One suitable nanowire material comprises aluminum nitride nanorods having a diameter in a range between approximately 10 nm and 50 nm and a length of up to approximately 500 microns. In some alternative examples, nanowire materials such as silicon carbide may be used. Suitable nanowire materials generally have high aspect ratios to generate an efficient path for percolation of thermal energy and high thermal conductivity.

Treatment of the nanowire material to enhance compatibility may comprise direct covalent modification of the nanowire material or addition of a surfactant. In some implementations, trimethoxoctylsilane may be applied to the nanowire material to passivate the surface of the nanowire material, making it dispersible in non-polar solvents. In some alternative implementations, a surfactant such as octylphosphonic acid may be used to form an organic layer on the nanowire material, without covalent attachment. Treatment of the nanowire material may be selected to provide a loading level of approximately 30%. This level is sufficient to trap the liquid PCM in the nanowire mesh by capillary forces and provides excellent thermal performance but does not displace significant amounts of PCM (which would sacrifice the ability of the composite to absorb heat). It is to be appreciated that in some implementations, the nanowire material may not be treated and block 12 may be eliminated.

Block 12 may be followed by block 14. At block 14, the nanowire material may be dispersed in a nonpolar solvent. One suitable nonpolar solvent is hexane. Nonpolar or less polar solvents may be used to match polarity of the PCM.

Block 14 may be followed by block 16. At block 16, the PCM may be added to the nanowire-solvent dispersion. The PCM may be chosen such that its melting point is near the temperature of interest. The PCM acts to cap the top temperature that may be reached in the electronics that it is protecting. This expands the amount of energy that can be pumped into the system without exceeding that top temperature. For an electronics application, the temperature of interest may be higher. More specifically, an electronic circuit (e.g., a micro-chip, or an assembled PC board, etc.) generally has a reliability limit (e.g., an upper end operating temperature limit) to which it has been tested. The PCM may thus be selected to have a melting point near the reliability limit of the electronic circuit. One suitable PCM is Lauric acid, having a melting point at 43° C.

Block 16 may be followed by block 18. At block 18, the nanowire-solvent-PCM dispersion may be heated to a temperature above the freezing point of the PCM. Heating may be done using any suitable device. For example, heating may be done using a heating element associated with the tank. Generally, the compatibility of nanowires and PCM leads to good dispersion stability. A more homogenous film of PCM composite is created when the solvent is evaporated at a temperature above the melt temperature of the PCM. However, lower temperatures may also be used.

Heating of the solvent-PCM dispersion, as shown at block 18, can speed dissolution of the PCM, and/or accelerate solvent evaporation. In some examples, however, heating may not be performed.

Block 18 may be followed by block 20. At block 20, the solvent is removed from the nanowire-solvent PCM, thereby leaving the PCM composite is removed. Solvent removal may be done in any suitable manner. In another example, solvent removal may be done by evaporating off the solvent. In other examples, solvent removal may be done by pouring off or pipetting the solvent from the tank.

Block 20 may be followed by block 22. At block 22, the remaining PCM composite may be formed into a suitable shape.

Block 22 may be followed by block 24. At block 24, the resulting formed PCM composite can be applied to a thermal source (e.g., the targeted chip, circuit, PC board, etc.). Application may be directly to the thermal source or to an intermediary. Such intermediary may be, for example, thermally conductive grease, paste, adhesive, or copper film. The amount of nanowire material and PCM dispersed may be chosen such that the resultant PCM composite is of suitable size for direct usage with the thermal source. More specifically, the PCM composite may be formed in a container having an area generally the size used in application to a thermal source; for example, if the thermal source has a surface area of 1 sq. cm., the surface area of the bottom of the container may be 1 sq. cm. such that, after removal of the solvent, the PCM composite settles in the 1 sq. cm. For example, a PCM composite may be manufactured having dimensions exceeding that for direct usage with the thermal source and thereafter subdivided. For example, if the thermal source has a surface area of 1 sq. cm. and the bottom of the container is 10 sq. cm., the resultant PCM composite may be subdivided into 10 1 sq. cm. units.

During use of the thermal source, the PCM composite is maintained in thermal contact with the thermal source at least because each melt cycle (heating of the PCM to a molten state) provides a new opportunity to form a wetted surface interface. Accordingly, the surface of the PCM composite reconforms to the surface of the thermal source each melt cycle, providing good adhesion through van der Walls forces.

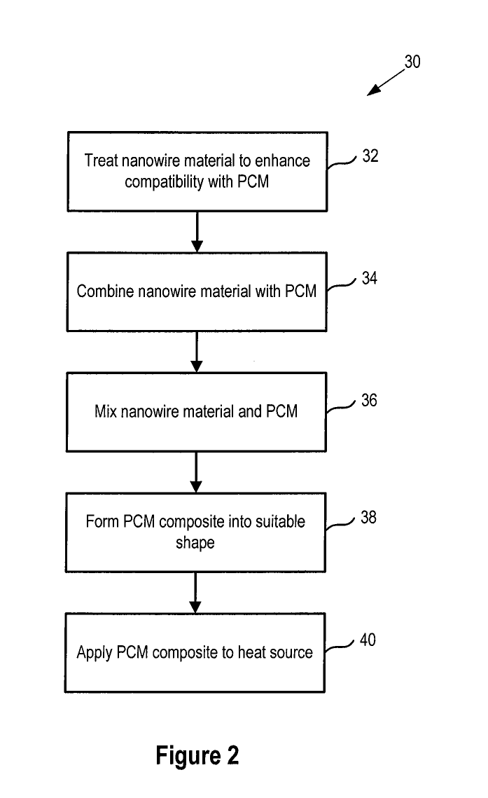

FIG. 2 illustrates an example of a second method 30 for forming a PCM composite, in accordance with at least some examples of the present disclosure. Method 30 may one or more functions, operations or actions as are illustrated by blocks 32, 34, 36, 38 and/or 40. Processing may begin at block 32.

At block 32, the nanowire material may be treated to enhance compatibility with the PCM, as described with respect to FIG. 1.

Block 32 may be followed by block 34. At block 34, a nanowire material may be combined with the PCM.

Block 34 may be followed by block 36. At block 36, the nanowire material and the PCM may be manually mixed to provide a PCM composite. Such mixing may, in some implementations, comprise pulling the nanowire material through the wax in the molten state to encapsulate the nanowire material.

Block 36 may be followed by block 38. At block 38, the resultant PCM composite from block 36 may be formed into a suitable shape.

Block 36 may be followed by block 30. At block 40, the formed PCM composite may be applied to a thermal source.

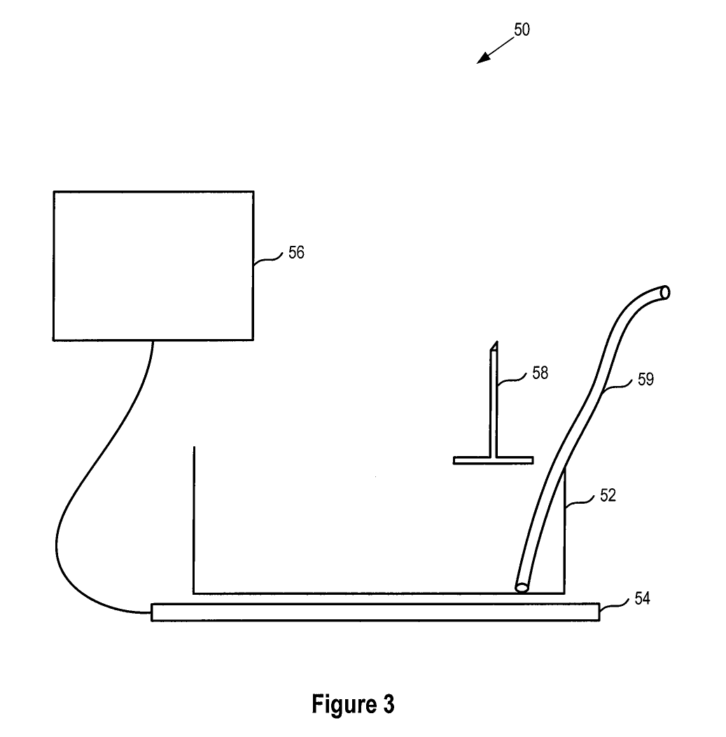

FIG. 3 illustrates a schematic view of a first example system 50 for forming a PCM composite, in accordance with at least some examples of the present disclosure. As shown, the example system 50 includes a tank 52, a heating element 54, a controller 56, and a forming element 58. In some embodiments, a removal element 59 may also be provided. The solvent, nanowire material, and PCM may be dispersed in the tank 52. The heating element 54 is configured to selectively heat the tank to a temperature suitable for removing the solvent. A temperature probe or some other thermal monitoring device may be configured to monitor the operating temperature of either the heating element 54 or the material in the tank 52. The forming element 58 may be configured to form the remaining PCM composite to a suitable shape and/or size (e.g., shaped and sized for application to a specific thermal source). The removal element 59 may be associated with the tank 52 and configured for removing the solvent from the tank 52, such as by evaporating solvent from the tank. The controller 56 may be coupled to one or more of the heating element 54, temperature monitoring device(s), and/or the forming element 58. The controller 56 can be any appropriate controlling device (e.g., a computing device, micro-processor, micro-controller, etc.) that is configured to control process parameters such as heating temperature set point, heating time, cooling time, forming, etc. The system shown in FIG. 3 may be used for forming a PCM composite in accordance with the example method of FIG. 1.

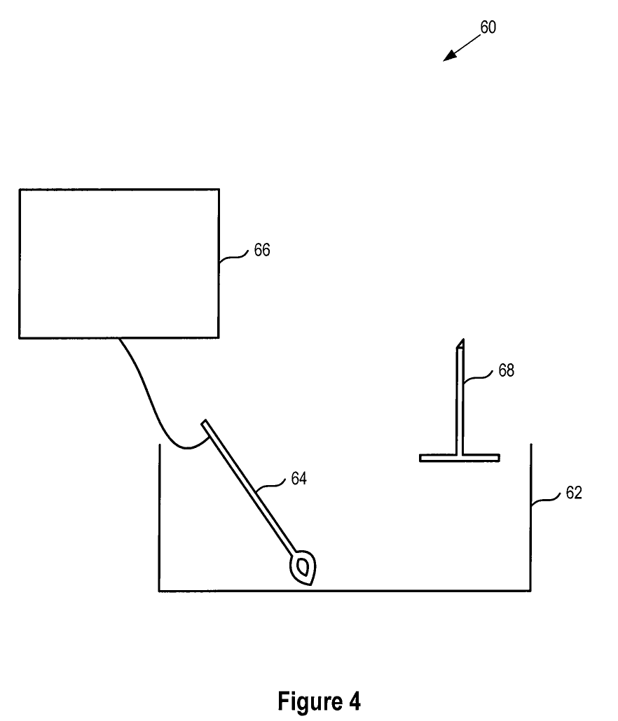

FIG. 4 illustrates a schematic view of a second example system 60 for forming a PCM composite, in accordance with at least some examples of the present disclosure. As shown, the system 60 includes a tank 62, a mixing element 64, a controller 66, and a forming element 68. The nanowire material and PCM may be admixed in the tank 62. The mixing element 64 is configured to selectively mix the nanowire material and the PCM. A temperature probe or some other thermal monitoring device may be configured to monitor the operating temperature of the material in the tank 652. The firming element 68 may be configured to the PCM composite to a suitable shape and/or size (e.g., shaped and sized for application to a specific thermal source). The controller 66 may be coupled to one or more of the forming element 68 or temperature monitoring device(s). The controller 66 can be any appropriate controlling device (e.g., a computing device, micro-processor, micro-controller, etc.) that is configured to control process parameters such as temperature, set point, mixing speed, forming, etc.

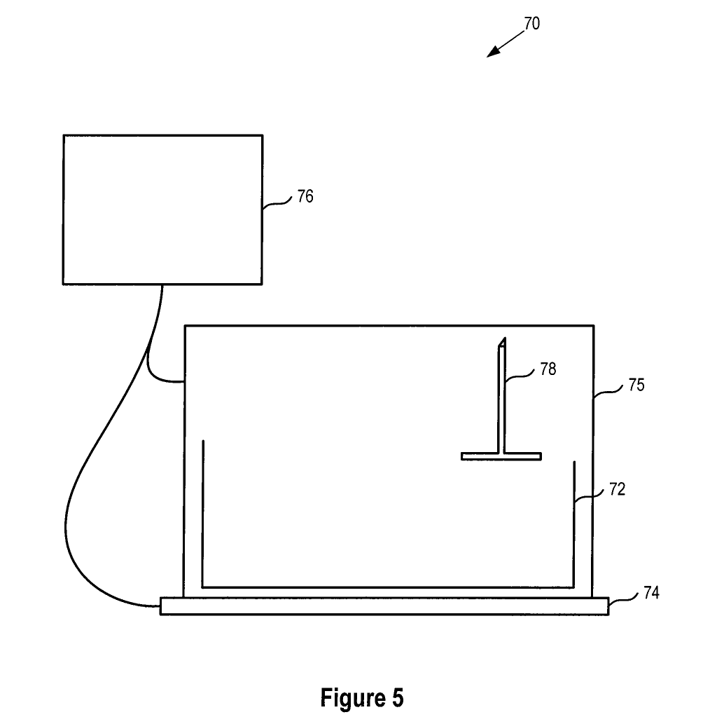

FIG. 5 illustrates a schematic view of a third example system 70 for forming a PCM composite, in accordance with at least some examples of the present disclosure. As shown, the example system 70 includes a tank 72, a heating element 74, a pressure chamber 75, a controller 76, and a forming element 78. The solvent, nanowire material, and PCM may be dispersed in the tank 72. The heating element 54 is configured to selectively heat the tank to a temperature suitable for removing the solvent. A temperature probe or some other thermal monitoring device may be configured to monitor the operating temperature of either the heating element 74 or the material in the tank 72. The pressure chamber 75 may be configured to selectively pressurize the tank 72. The forming element 78 may be configured to form the remaining PCM composite to a suitable shape and/or size (e.g., shaped and sized for application to a specific thermal source). The controller 76 may be coupled to one or more of the heating element 54, the pressure chamber 75, temperature monitoring device(s), and/or the forming element 78. The controller 76 can be any appropriate controlling device (e.g., a computing device, micro-processor, micro-controller, etc.) that is configured to control process parameters such as heating temperature set point, heating time, cooling time, forming, etc.

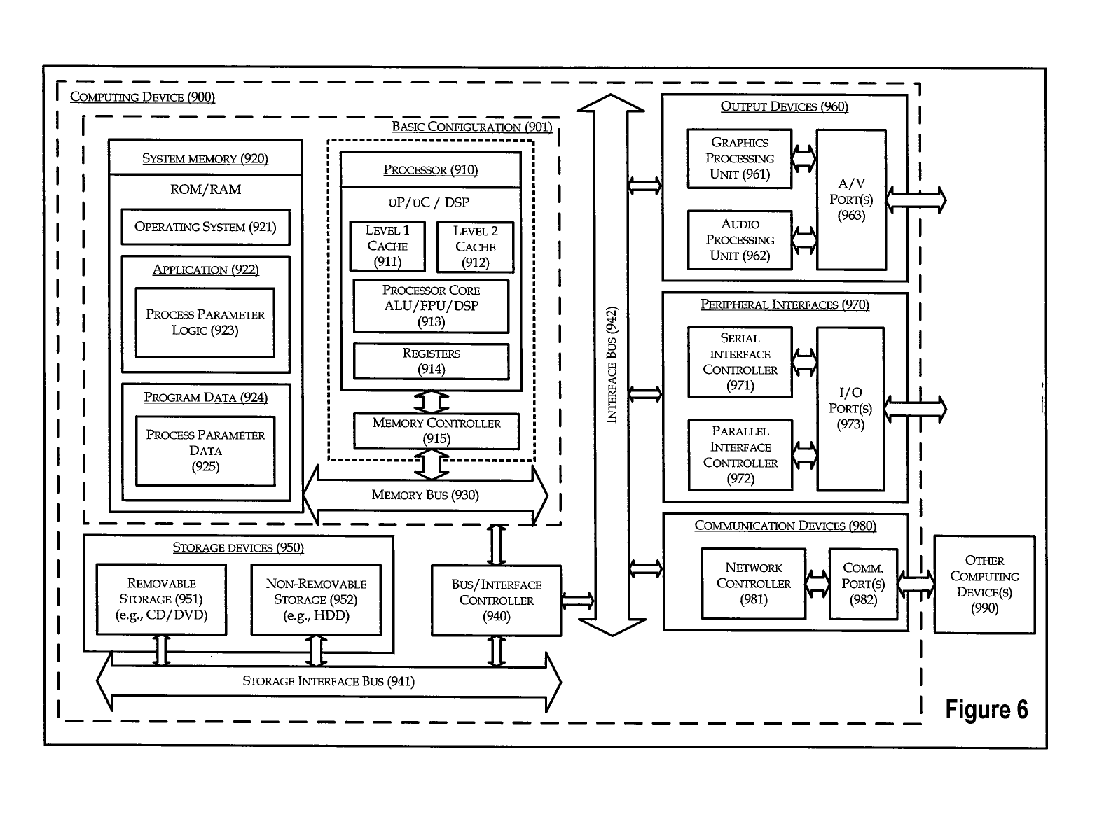

FIG. 6 is a block diagram illustrating an example computing device 900 that is arranged for producing a PCM composite in accordance with the present disclosure. The computing device is one example device that may be used as the controller of FIG. 3, FIG. 4, or FIG. 5, but other example devices are also contemplated. In a very basic configuration 901, computing device 900 typically includes one or more processors 910 and system memory 920. A memory bus 930 may be used for communicating between the processor 910 and the system memory 920.

Depending on the desired configuration, processor 910 may be of any type including but not limited to a microprocessor (μP), a microcontroller (μC), a digital signal processor (DSP), or any combination thereof. Processor 910 may include one more levels of caching, such as a level one cache 911 and a level two cache 912, a processor core 913, and registers 914. An example processor core 913 may include an arithmetic logic unit (ALU), a floating point unit (FPU), a digital signal processing core (DSP Core), or any combination thereof. An example memory controller 915 may also be used with the processor 910, or in some implementations the memory controller 915 may be an internal part of the processor 910.

Depending on the desired configuration, the system memory 920 may be of any type including but not limited to volatile memory (such as RAM), non-volatile memory (such as ROM, flash memory, etc.) or any combination thereof. System memory 920 may include an operating system 921, one or more applications 922, and program data 924. Application 922 may include a process parameter logic 923 for controlling process parameters for forming a PCM composite in accordance with any of the techniques described herein. Program Data 924 includes process parameter data including, for example, temperature controls, pressure controls, or others 925. In some examples, temperature controls may control temperature set point(s), time duration(s), and/or cooling time(s) of a stainless steel autoclave. In some embodiments, application 922 may be arranged to operate with program data 924 on an operating system 921 such that the computing device may be operably associated with a system for forming a PCM composite and may control process parameters of the system for forming a PCM composite. This described basic configuration is illustrated in FIG. 6 by those components within dashed line 901.

Computing device 900 may have additional features or functionality, and additional interfaces to facilitate communications between the basic configuration 901 and any required devices and interfaces. For example, a bus/interface controller 940 may be used to facilitate communications between the basic configuration 901 and one or more data storage devices 950 via a storage interface bus 941. The data storage devices 950 may be removable storage devices 951, non-removable storage devices 952, or a combination thereof. Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media may include volatile and nonvolatile, removable and non-removable media implemented in any method or technology for storage of information, such as computer readable instructions, data structures, program modules, or other data.

System memory 920, removable storage 951 and non-removable storage 952 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by computing device 900. Any such computer storage media may be part of device 900.

Computing device 900 may also include an interface bus 942 for facilitating communication from various interface devices (e.g., output interfaces, peripheral interfaces, and communication interfaces) to the basic configuration 901 via the bus/interface controller 940. Example output devices 960 include a graphics processing unit 961 and an audio processing unit 962, which may be configured to communicate to various external devices such as a display or speakers via one or more A/V ports 963. Example peripheral interfaces 970 include a serial interface controller 971 or a parallel interface controller 972, which may be configured to communicate with external devices such as input devices (e.g., keyboard, mouse, pen, voice input device, touch input device, etc.) or other peripheral devices (e.g., printer, scanner, etc.) via one or more I/O ports 973. An example communication device 980 includes a network controller 981, which may be arranged to facilitate communications with one or more other computing devices 990 over a network communication link via one or more communication ports 982.

The network communication link may be one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

Computing device 900 may be implemented as a portion of a small-form factor portable (or mobile) electronic device such as a cell phone, a personal data assistant (PDA), a personal media player device, a wireless web-watch device, a personal headset device, an application specific device, or a hybrid device that include any of the above functions. Computing device 900 may also be implemented as a personal computer including both laptop computer and non-laptop computer configurations.

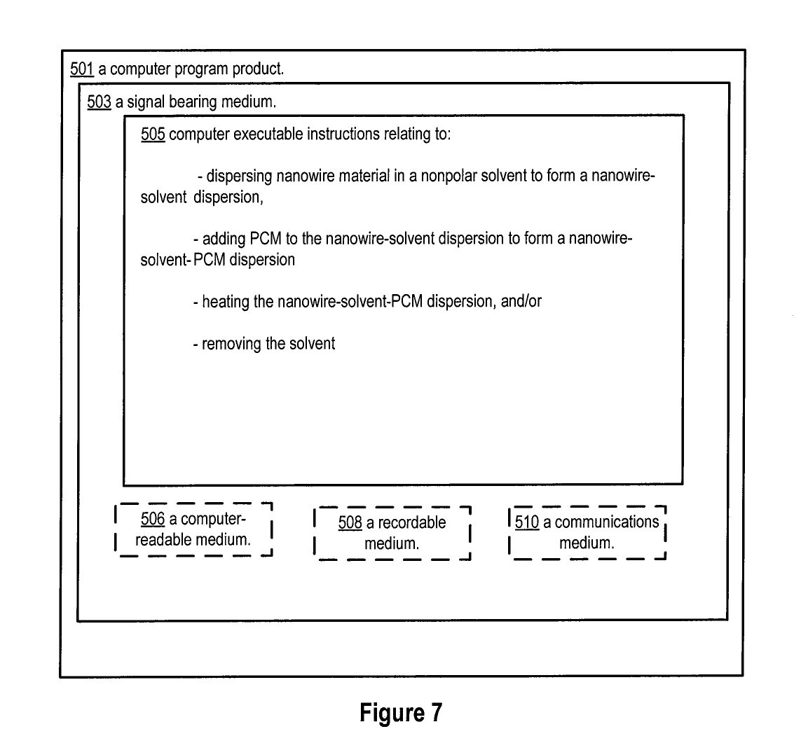

FIG. 7 illustrates a block diagram of an example computer program product 501 arranged in accordance with the present disclosure. In some examples, as shown in FIG. 6, computer program product 501 includes a signal bearing medium 503 that may also include computer executable instructions 505. Computer executable instructions 505 may be arranged to provide instructions for forming a PCM composite in accordance with any of the techniques describe herein. In some examples, the computer executable instructions may include instructions relating to dispersing nanowire material in a nonpolar solvent to form a nanowire-solvent dispersion, adding PCM to the nanowire-solvent dispersion to form a nanowire-solvent-PCM dispersion, heating the nanowire-solvent-PCM dispersion, and removing the solvent. More generally, the computer executable instructions may relate to rate of heating, temperature set point(s), rate of cooling, mixing speed, mixing time, pressure, or some other process parameter.

Also depicted in FIG. 7, in some examples, computer product 500 may include one or more of a computer readable medium 506, a recordable medium 508 and a communications medium 510. The dotted boxes around these elements may depict different types of mediums that may be included within, but not limited to, signal bearing medium 502. These types of mediums may distribute computer executable instructions 505 to be executed by computer devices including processors, logic and/or other facility for executing such instructions. Computer readable medium 506 and recordable medium 508 may include, but are not limited to, a flexible disk, a hard disk drive (HDD), a Compact Disc (CD), a Digital Video Disk (DVD), a digital tape, a computer memory, etc. Communications medium 510 may include, but is not limited to, a digital and/or an analog communication medium (e.g., a fiber optic cable, a waveguide, a wired communication link, a wireless communication link, etc.).

The present disclosure is not to be limited in terms of the particular examples described in this application, which are intended as illustrations of various aspects. Many modifications and variations may be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds compositions or biological systems, which can, of course, vary. It is also to be understood that the terminology used herein is for the purpose of describing particular examples only, and is not intended to be limiting. These are for illustration only and are not intended to be limiting.

The present disclosure generally relates to systems and methods for forming a PCM composite and the PCM composite thus formed. In one example, a first method for forming a PCM composite is described. The method may include dispersing nanowire material in a nonpolar solvent to form a nanowire-solvent dispersion, adding PCM to the nanowire-solvent dispersion to form a nanowire-solvent-PCM dispersion, and removing the solvent.

In another example, another method for forming a PCM composite is described. The method may include treating the nanowire material to enhance compatibility with PCM, combining the nanowire material with PCM, and mixing the combined nanowire material and PCM.

In yet another example, a phase change material composite is described. The phase change material composite may comprise a phase change material and a network of covalent or surfactant modified nanowires dispersed in the phase change material, wherein the nanowires have a diameter between approximately 10 nm and 50 nm and a length of up to approximately 500 microns, wherein the phase change material composite has a modulus of >1 GPa.

In a further example, a computer accessible medium having stored thereon computer executable instructions for forming phase change material composites is described. In this example, the computer executable instructions may include instructions for forming comprises dispersing nanowire material in a nonpolar solvent to form a nanowire-solvent dispersion, adding PCM to the nanowire-solvent dispersion to form a nanowire-solvent-PCM dispersion, heating the nanowire-solvent-PCM dispersion, and removing the solvent.

There is little distinction left between hardware and software implementations of aspects of systems; the use of hardware or software is generally (but not always, in that in certain contexts the choice between hardware and software may become significant) a design choice representing cost vs. efficiency tradeoffs. There are various vehicles by which processes and/or systems and/or other technologies described herein may be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; if flexibility is paramount, the implementer may opt for a mainly software implementation; or, yet again alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples may be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Video Disk (DVD), a digital tape, a computer memory, etc.; and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity; control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components contained within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable”, to each other to achieve the desired functionality. Specific examples of operably couplable include but are not limited to physically matable and/or physically interacting components and/or wirelessly interactable and/or wirelessly interacting components and/or logically interacting and/or logically interactable components.

With respect to the use of substantially any plural and/or singular terms herein, those having skill in the art may translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range may be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like include the number recited and refer to ranges which may be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. A method for forming a phase change material (PCM) composite comprising:
treating a nanowire material to enhance compatibility with the PCM;
dispersing the nanowire material in a nonpolar solvent to form a nanowire-solvent dispersion;
combining the nanowire material with PCM to form an admixture; and
mixing the admixture to form a PCM-composite.

2. The method of claim 1, wherein combining the nanowire material with the PCM comprises adding PCM to the nanowire-solvent dispersion to form the admixture, and wherein the admixture comprises a nanowire-solvent-PCM dispersion.

3. The method of claim 2, further comprising heating the nanowire-solvent PCM dispersion.

4. The method of claim 3, further comprising removing the solvent from the nanowire-solvent dispersion after formation of the admixture.

5. The method of claim 2, further comprising heating the nanowire-solvent PCM dispersion to a temperature above a melt temperature of the PCM.

6. The method of claim 2, wherein the nonpolar solvent is hexane.

7. The method of claim 1, wherein treating the nanowire material comprises direct covalent modification of the nanowire material.

8. The method of claim 1, wherein treating the nanowire material comprises applying a surfactant to the nanowire material.

9. The method of claim 8, wherein the surfactant is either trimethoxoctylsilane or octylphosphonic acid.

10. The method of claim 1, further comprising forming the PCM composite into a suitable shape.

11. The method of claim 1, wherein mixing comprises pulling the nanowire material through the PCM in a molten state to encapsulate the nanowire material.

12. The method of claim 1, further comprising dissolving the PCM in a solvent to form a PCM-solvent dispersion, wherein combining the nanowire material with the PCM comprises adding the nanowire material to the PCM-solvent dispersion to form the admixture, and wherein the admixture comprises a nanowire-solvent-PCM dispersion.

13. The method of claim 1, wherein combining the nanowire material with the PCM comprises adding the nanowire material and the PCM to a solvent substantially simultaneously to form an admixture, and wherein the admixture comprises a nanowire-solvent-PCM dispersion.

14. A phase change material composite comprising:
a phase change material (PCM);
a network of covalent or surfactant modified nanowires dispersed in the phase change material (PCM), wherein the nanowires have a diameter in a range between approximately 10 nm and approximately 50 nm, and wherein the nanowires have a length of up to approximately 500 microns; and
wherein the phase change material composite has a modulus of >1 GPa and the network of covalent or surfactant modified nanowires are configured to hold a liquid form of the PCM using capillary forces when the material is above a melting point of the PCM.

15. The phase change material of claim 14, wherein the nanowires are modified with either trimethoxoctylsilane or octylphsophonic acid.

16. The phase change material of claim 15, wherein the nanowire material is aluminum nitride.

17. The phase change material of claim 15, wherein the phase change material is Lauric acid.

18. A system for forming a phase change material (PCM) composite, comprising:
a tank configured to receive a nonpolar solvent, a nanowire material, and a PCM;
a heating element associated with the tank and configured to selectively heat the tank to a temperature suitable for removing the solvent and dispersing the nanowire material in the PCM to form a network of nanowires dispersed in the PCM, and wherein the network of nanowires are configured to hold a liquid form of the PCM using capillary forces when the temperature is above a melting point of the PCM;
a forming element configured to form remaining PCM composite to a suitable shape and/or size; and
a controller coupled to one or more of the heating element and/or the forming element and configured to control process parameters associated with the system for forming the PCM.

19. The system of claim 18, wherein the solvent, nanowire material, and PCM in the tank together comprise the contents of the tank, and further comprising a temperature probe configured to monitor the operating temperature of one or more of the heating element or the contents of the tank.

20. The system of claim 18, further comprising a removal element associated with the tank and configured for removing the solvent from the tank.

21. The system of claim 18, further comprising a pressure chamber associated with the tank and configured to selectively pressurize the tank.

22. A computer accessible medium having stored thereon computer executable instructions which, when executed by a computing device, configure the computing device to perform a method for forming phase change material (PCM) composites, the method comprising:
dispersing a treated nanowire material in a nonpolar solvent to form a nanowire-solvent dispersion;
adding a PCM to the nanowire-solvent dispersion to form a nanowire-solvent-PCM dispersion; and
forming a resulting PCM composite by admixture of the PCM and nanowire material in the nanowire-solvent-PCM dispersion.

23. The computer accessible medium of claim 22, further comprising heating the nanowire-solvent PCM dispersion and removing the solvent to leave the resulting PCM composite.

24. The method of claim 1, wherein the nanowire material comprises aluminum nitride nanorods.

25. The method of claim 1, wherein said treating a nanowire material to enhance compatibility with the PCM comprises providing a loading level of approximately 30 percent.

26. The method of claim 1, wherein the PCM comprises a wax material.
